(19) United States
(12) Patent Application Publication
(10) Pub. No.: US 2009/0060833 A1
(43) Pub. Date: Mar. 5, 2009

(54) Fuel Compositions for Fuel Cells and Gas Generators Utilizing Same

(75) Inventors: Andrew J. Curello, Hamden, CT (US); Alain Rosenzweig, Saint Maur Des Fosses (FR)

Correspondence Address: THE H.T. THAN LAW GROUP, WATERFRONT CENTER SUITE 560, 1010 WISCONSIN AVENUE NW, WASHINGTON, DC, 20007, US

(73) Assignee: Societe BIC, Clichy Cedex (FR)

(21) Appl. No.: 12/293,027

(22) PCT Filed: Mar. 14, 2007
(86) PCT No.: PCT/US07/06384

§ 371 Date: Oct. 22, 2008

Related U.S. Application Data
(60) Provisional application No. 60/782,632, filed on Mar. 15, 2006.

(51) Int. Cl. C01B 3/04; B01J 19/00

(52) U.S. Cl. 423/658.2; 422/129

(57) ABSTRACT

In a reaction of water or other reactable liquids with solid borohydride fuels, the liquid reactant and/or additives are converted to a gel form (14). The solid metal hydride and catalyst are formed into a single solid member (26). The single metal hydride/catalyst member is inserted into the gel (14) to initiate the reaction to produce hydrogen and is withdrawn from the gel to stop or slow the reaction. A self-regulating gas generator (10, 40) using such a fuel-production formulation automatically controls the reaction rate thereof to control the internal pressure of the gas generator.

### FIELD OF THE INVENTION

The invention is directed to novel fuel compositions for fuel cells, and more particularly novel fuel compositions that produce hydrogen for use in fuel cells.

### BACKGROUND OF THE INVENTION

A known challenge in the hydrogen generation art is to control the reaction rate between a chemical metal hydride, such as sodium borohydride, and a liquid, such as water or methanol. When the reaction is too slow, the fuel cell does not have sufficient hydrogen to generate electricity. When the reaction is too fast, the excess hydrogen gas can pressurize the fuel supply.

Heretofore, control of the reaction rate to produce hydrogen in a chemical metal hydride reaction has been accomplished by introducing the catalyst into a reaction chamber containing aqueous metal hydride and water to start the reaction and removing the catalyst therefrom to stop the reaction, as disclosed in U.S. Pat. Nos. 6,939,529 and 3,459,510 and in U.S. Patent Publication No. US 2005/0158595. This technique regulates the rate of reaction by controlling how much the catalyst interacts with the aqueous fuel or the duration of contact between the catalyst and the fuel.

Another method of controlling the reaction rate is to add metal hydride granules having uniform size into water at a steady rate to control the production of hydrogen as discussed in U.S. Patent Publication No. US 2004/0184987. Another method is to control the injection rate of water and aqueous metal hydride solution to control the reaction rate.

However, there remains a need for additional methods to control the reaction rate.

### BRIEF SUMMARY OF THE INVENTION

One aspect of the invention is directed toward a fuel composition capable of producing hydrogen through an oxidation reaction for use in a fuel cell. The fuel composition includes a gel reactant, a chemical metal hydride reactant and a catalyst.

Another aspect of the invention is directed toward a gas generator adapted for use with the fuel composition that includes a gel reactant, a chemical metal hydride reactant and a catalyst. The gas generator includes a chamber containing the gel reactant, wherein the solid reactant is positioned on a biased platform and the solid reactant is movable relative to the gel reactant. The gel reactant is spaced apart from the platform to form a pressure chamber. The gas produced from a reaction between the gel reactant and the metal hydride reactant creates a pressure within the pressure chamber. When the pressure is higher than a predetermined pressure, the solid reactant is moved away from the gel reactant. When the pressure is lower than the predetermined pressure, the solid reactant is moved toward the gel reactant.

Another aspect of the invention is directed toward a gas generator capable of producing hydrogen through an oxidation reaction. The gas generator contains a liquid reactant and a chemical metal hydride. The gas generator includes a hydrogen sorbent alloy/metal to absorb excess hydrogen.

### BRIEF DESCRIPTION OF DRAWINGS

The foregoing and other features and advantages of the invention will be apparent from the following description of the invention as illustrated in the accompanying drawings. The accompanying drawings form a part of the specification to explain the principles of the invention and to enable a person skilled in the pertinent art to make and use the invention.

FIG. 1 is a cross-sectional view of a hydrogen gas generator in accordance with the present invention; FIG. 1A is a front view of a supporting wall used in the hydrogen gas generator of FIG. 1; FIG. 1B is a cross-sectional view of a variation of the gas generator of FIG. 1;

FIG. 2 is a cross-sectional view of another hydrogen gas generator in accordance to the present invention; and FIG. 2A is a perspective view of a screen used in the hydrogen gas generator of FIG. 2.

### DETAILED DESCRIPTION OF THE INVENTION

The general reaction between a metal hydride reactant and a liquid reactant to produce hydrogen is known. In one example, the reaction between sodium borohydride and water is as follows:

NaBH₄+2H₂O→(catalyst)→4(H₂)+(NaBO₂)

Suitable catalysts include platinum, ruthenium and ruthenium salt (RuCl₃), among other metals and salts thereof. Sodium borate (NaBO₂) byproduct is also produced by the reaction. Sodium borohydride fuel as used in fuel cells is discussed in U.S. Pat. No. 3,459,510, which is incorporated herein by reference.

As illustrated in the accompanying drawings and discussed in detail below, the present invention is directed to methods and compositions capable of controlling and maximizing the release of hydrogen from chemical metal hydride fuels, such as sodium borohydride (NaBH₄), and water. The present invention is also directed to self-regulating apparatuses that maximize the release of hydrogen fuels from a reaction of chemical metal hydride fuels and water.

Hydrogen generating apparatuses using chemical metal hydride fuels are disclosed in co-pending U.S. application Ser. No. 10/679,756 filed on Oct. 6, 2003, U.S. application Ser. No. 11/067,167 filed on Feb. 25, 2005, U.S. application Ser. No. 11/066,573 filed on Feb. 25, 2005, U.S. Provisional Application No. 60/689,538 filed on Jun. 13, 2005, and U.S. Provisional Application No. 60/689,539 filed on Jun. 13, 2005. The disclosures of all of these references are incorporated by reference herein in their entireties.

Suitable chemical metal hydride fuels include, but are not limited to, hydrides of elements of Groups IA-IVA of the Periodic Table of the Elements and mixtures thereof, such as alkaline or alkali metal hydrides, or mixtures thereof. Other compounds, such as alkali metal-aluminum hydrides (alanates) and alkali metal borohydrides may also be employed. More specific examples of metal hydrides include, but are not limited to, lithium hydride, lithium aluminum hydride, lithium borohydride, sodium hydride, sodium borohydride, potassium hydride, potassium borohydride, magnesium hydride, magnesium borohydride, calcium hydride, and salts and/or derivatives thereof. The preferred hydrides are sodium hydride, sodium borohydride, magnesium borohydride, lithium borohydride, and potassium borohydride, more preferably NaBH₄ and/or Mg(BH₄)₂.

Liquids other than water, such as methanol and other alcohols, can also be used to react with chemical metal hydrides.

In solid form, NaBH₄, which is typically in the form of powder or granules or in the solid form of pressed particles, does not readily hydrolyze in the absence of water, and therefore using anhydrous borohydride improves shelf life of the fuel supply or gas generator. However, the aqueous form of hydrogen-bearing fuel, such as aqueous NaBH₄, typically hydrolyzes readily unless a stabilizing agent is present. Exemplary stabilizing agents can include, but are not limited to, metals and metal hydroxides, such as alkali metal hydroxides, e.g., KOH and/or NaOH. Examples of such stabilizers are described in U.S. Pat. No. 6,683,025, which is incorporated by reference herein in its entirety.

The solid form of the hydrogen-bearing fuel is generally preferred over the aqueous form. In general, solid fuels are thought to be more advantageous than liquid fuels because the aqueous fuels contain proportionally less energy than the solid fuels and the liquid fuels are typically less stable than the solid fuels.

One of the problems associated with the solid forms of NaBH₄ (pellet, granule, powder, agglomerate, etc.) is that, during the oxidation of the borohydride by water, metaborate (BO₂⁻) byproduct can appear on the surface of the solid. As the oxidation reaction continues, the metaborate and other forms of borates tend to form a skin or shell on the surface of the borohydride solid, which can inhibit the borohydride-water oxidation reaction. Furthermore, metaborate and other borate ions can absorb several molecules of water each, reacting with some and chelating with others, which causes the metal hydride oxidation reaction to need more water than the ideal stoichiometric reaction. Also, it is believed that the water must pass through the borate skin and not be chelated by, or reacted with, the borate oxidation byproducts before reaching the borohydride beneath. Even though metaborate and other borate ions are less reactive with water than the borohydride molecules, the borate skin causes the borohydride-water reaction to be rate limiting.

Additionally, the reaction between NaBH₄ and water, once it begins, can be difficult to control, such that hydrogen may be produced unevenly with a spike in hydrogen production when fresh reactants are combined. When the gas is produced too quickly after fresh reactants are reacted, the gas can over-pressurize a fuel supply or hydrogen generator and damage the fuel supply. Additionally, if high pressure is communicated to a fuel cell, it can also damage the fuel cell.

In accordance with the present invention the reaction of water or other reactable liquids with solid borohydride fuels can be modified as follows: converting the liquid reactant and/or additives to a gel form, forming the solid metal hydride and catalyst into a single solid member, inserting the single metal hydride/catalyst member into the gel to start the reaction to produce hydrogen and withdrawing the metal hydride/catalyst member from the gel to stop or slow the reaction. Another aspect of the invention concerns a self-regulating gas generator that automatically controls the reaction rate to control the internal pressure of gas generator.

In one embodiment, the liquid reactant is formed into a gel so that the liquid molecules are reversibly encapsulated in a matrix until it is needed for the reaction. In this way, the liquid component is not free-flowing to react at will. Water-insoluble, but water-swellable polymers capable of absorbing liquids are used in the present invention. When a water-insoluble, water-swellable material is added to water, the bond between the water-insoluble, water-swellable compound and water is sufficiently strong to hold the water, but sufficiently weak to surrender water molecules when another reaction, i.e., between water and NaBH₄, needs the water. Preferred water-insoluble, water-swellable materials include sodium polyacrylate, commonly used in infant diaper products, and polyacrylamide, among others. Suitable water-insoluble, water-swellable materials are described in U.S. Pat. No. 6,998,367 B2 and references cited therein. The water-insoluble, water-swellable polymers discussed in these references are incorporated herein by reference.

In one embodiment, a copolymer of sodium polyacrylate and bis-acrylamide, where two sodium polyacrylate chains are connected by the bis-acrylamide to resemble railroad tracks. This polymer contains many sites that can absorb water molecules by hydrogen bonding. Without being bounded by any particular theories, the inventor believes that these hydrogen bonds are weaker than the tendency of NaBH₄ to react with the bonded water in the presence of a catalyst, such as ruthenium salt, such that the hydrogen bonds release the water molecules to react with the NaBH₄. Additionally, activators, materials that prime the catalyst for reaction, may also be included. Any activator known in the art for use with the particular catalysts selected may be used in the present invention.

Other suitable water-insoluble, water-swellable polymers are disclosed in U.S. Pat. No. 6,998,377 B2, which is incorporated herein by reference in its entirety. The absorbent polymers of the present invention may also include at least one hydrogel-forming absorbent polymer (also referred to as hydrogel-forming polymer). Suitable hydrogel-forming polymers include a variety of water-insoluble, water-swellable polymers capable of absorbing liquids.

The hydrogel-forming absorbent polymers useful in the present invention can have a size, shape and/or morphology varying over a wide range. These polymers can be in the form of particles that do not have a large ratio of greatest dimension to smallest dimension (e.g., granules, pulverulents, interparticle aggregates, interparticle crosslinked aggregates, and the like) and can be in the form of fibers, sheets, films, foams, flakes and the like. The hydrogel-forming absorbent polymers can also comprise mixtures with low levels of one or more additives, such as powdered silica, zeolites, activated carbon, molecular sieves, surfactants, glue, binders, and the like. The components in this mixture can be physically and/or chemically associated in a form such that the hydrogel-forming polymer component and the non-hydrogel-forming polymer additive are not readily physically separable. The hydrogel-forming absorbent polymers can be essentially non-porous (i.e., no internal porosity) or have substantial internal porosity.

Gels based on acrylamide are also suitable for use in the present invention. Specifically suitable are acrylamide, 2-(acryloyloxyl)ethyl acid phosphate, 2-acyrlamido-2-methylpropanesulfonic acid, 2-dimethylaminoethyl acrylate, 2,2′-bis(acrylamido)acetic acid, 3-(methacrylamido)propyltrimethylammonium chloride, acrylamidomethylpropanedimethylammonium chloride, acrylate, acrylonitrile, acrylic acid, diallyldimethylammonium chloride, diallylammonium chloride, dimethylaminoethyl acrylate, dimethylaminoethyl methacrylate, ethylene glycol, dimethacrylate, ethylene glycol monomethacrylate, methacrylamide, methylacrylamidopropyltrimethylammonium chloride, N,N-dimethylacrylamide, N-[2 [[5-(dimethylamino) 1-naphthaleny]sulfonyl]amino[ethyl]-2-acrylamide, N-[3-dimethylamino)propyl]acrylamide hydrochloride, N-[3-(dimethylamino)propyl)methacrylamide hydrochloride, poly(diallyldimethylammonium chloride), sodium 2-(2-carboxybenzoyloxy)ethyl methacrylate, sodium acrylate, sodium allyl acetate, sodium methacrylate, sodium styrene sulfonate, sodium vinylacetate, triallylamine, trimethyl(N-acryloyl-3-aminopropyl)ammonium chloride, triphenylmethane-leuco derivatives, vinyl-terminated polymethylsiloxane, N-(2-ethoxyethyl)acrylamide, N-3-(methoxypropyl)acrylamide, N-(3-ethoxypropyl)acrylamide, N-cyclopropylacrylamide, N-n-propylacrylamide, and N-(tetrahydrofurfuryl)acrylamide.

Also suitable are the gels based on N-isopropylacrylamide. These can include N-isopropylacrylamide, 2-(diethylamino)ethyl methacrylate, 2-(dimethylamino)ethyl methacrylate, 2-acrylamido-2-methyl-1-propanesulfonacrylate, acrylic acid, acrylamide alkyl methacrylate, bis(4-dimethylamino)phenyl)(4-vinylphenyl)methyl leucocyanide, Concanavalin A (Lecithin), hexyl methacrylate, lauryl methacrylate, methacrylic acid, methacrylamidopropyltrimethylammonium chloride, n-butyl methacrylate, poly(tetrafluoroethylene), polytetramethylene ether glycol, sodium acrylate, sodium methacrylate, sodium vinyl sulfonate, and vinyl-terminated polymethylsiloxane.

Also suitable are the gels based on N,N′-diethylacrylamide. These can include N,N′-diethylacrylamide, methyacrylamidopropyltrimethylammonium chloride, N-acryloxysuccinimide ester, N-tert-butylacrylamide, and sodium methacrylate.

Gels based on acrylate are also suitable. These may include 2-dimethylaminoethyl acrylate, 2-acrylamido-2-methylpropanesulfonic acid, acrylamide, triallylamine, acrylate, acrylamide, methyl methacrylate, divinylbenzene, N,N-dimethylaminoethyl methacrylate, poly(oxytetramethylene dimethacrylate), poly(2-hydroxyethyl methacrylate), poly(2-hydroxypropyl methacrylate), and polyethylene glycol methacrylate.

Also suitable are the gels based on various monomers. These can include acrylic acid, methacrylamidopropyltrimethylammonium chloride, Collagen, dipalmitoylphosphatidylethanolamine, poly[4-6-decadiene-1,10-diolbis(n-butoxycarbonylmethyl urethane)], poly[bis[aminoethoxy)ethoxy]phosphazene], poly [bis[(butoxyethoxy)ethoxy]phosphazene], poly[bis [ethoxyethoxy)ethoxy]phosphazene], poly[bis[methoxyethoxy)ethoxy]phosphazene], poly[bis[methoxyethoxy)phosphazene], polydimethylsiloxane, polyethylene oxide, poly(ethylene-dimethylsiloxane-ethylene oxide), poly(N-acrylopyrrolidine), poly[n,n-dimethyl-N-[(methacryloyloxyethyl]-N-(3-sulfopropyl)ammonium betaine], polymethacrylic acid, polymethacryloyl dipeptide, polyvinyl alcohol, polyvinyl alcohol-vinyl acetate, polyvinyl methyl ether, furan-modified poly(n-acetylethylene imine), and malein imide-modified poly(n-acetylethylene imine).

Also suitable are the gels disclosed in U.S. Pat. Nos. 4,555,344, 4,828,710, and European Application EP 648,521 A2, which are incorporated by reference herein.

It is preferred that the catalyst is combined with NaBH₄ in a single solid mass, because some of the catalysts, e.g., ruthenium salt, may interfere with the gel formation. When this solid mass is brought into contact with the gel, water is released from the hydrogen bonds, due to the presence of the catalyst(s) or NaBH₄ or both, and reacts with NaBH₄ to form hydrogen and sodium borate, NaBO₂. Other factors, such as environmental factors, may also affect the gel formation and/or the ability of the material to remain in gel form without breaking down. These factors include temperature, pressure, and pH.

In one example, 37 grams of distilled water were added to 1 gram of sodium polyacrylate obtained from a diaper product to form a water gel, which has a translucent appearance. A solid pellet of 90% NaBH₄ and 10% RuCl₃ (by weight) was formed to create the solid fuel, which has a black color. An amount of gel and an amount of the solid fuel were selected so that the molar ratio between the water reactant and the NaBH₄ reactant was about 6:1. The solid pellet was inserted into the gel and a steady production of hydrogen was observed.

Substantially all or all of the solid fuel is reacted to form hydrogen without any readily discernible sign of the formation of skin or shell, regardless of whether the solid fuel/catalyst remains in contact with the gel for the duration of the reaction, or whether the fuel/catalyst solid is in contact intermittently with the gel, i.e., the fuel/catalyst solid is cycling into and out of contact with the gel. Furthermore, part of the solid pellet, which was black due to the RuCl₃, was observed to be spreading through the translucent water gel.

As described above, in a conventional reaction the NaBO₂ byproduct may form a skin or shell on the solid fuel mass thereby preventing some of the solid fuel encapsulated by the NaBO₂ skin from reacting. Without being bounded by any particular theory, in the present invention the produced hydrogen percolates through the interface between the gel reactant and the solid fuel reactant and this percolation may hinder the formation of the skin or shell. Additionally, since the NaBO₂ is also attracted to water for bonding or chelating and again without being bounded to any particular theory, the NaBO₂ byproduct's attraction to water is also greater than the hydrogen bond between the water and water-insoluble, water-swellable compound, i.e., sodium polyacrylate. Hence, instead of forming the skin or shell, the NaBO₂ byproduct seeks out water from the gel to react, and therefore the NaBO₂ byproduct is less likely to form the skin or shell. This is evidenced by the observation that during the reaction some of the black solid fuel leaches into the translucent gel.

In another aspect of the present invention, the rate of water leaving the gel state is balanced by the rate of water reacting with NaBH₄ and NaBO₂, so that there is sufficient amount of water available, as needed, to feed these reactions. The rate of water leaving the gel can be determined by the amount of catalyst and/or NaBH₄ available to the gel, the catalyst's and/or NaBH₄'s ability to draw the water away from the gel, the selection of the gel-forming compound and the selection of catalyst, among other things.

In accordance to another aspect of the present invention, a gas generator 10 is provided to generate hydrogen fuel from the gel reactant and solid NaBH₄/catalyst mass discussed above. An advantage of reversibly locking or encapsulating the water in a gel is that a cartridge, fuel supply or hydrogen generator using this gel can operate in the inverted position or in any orientation, since the water is not in a liquid state.

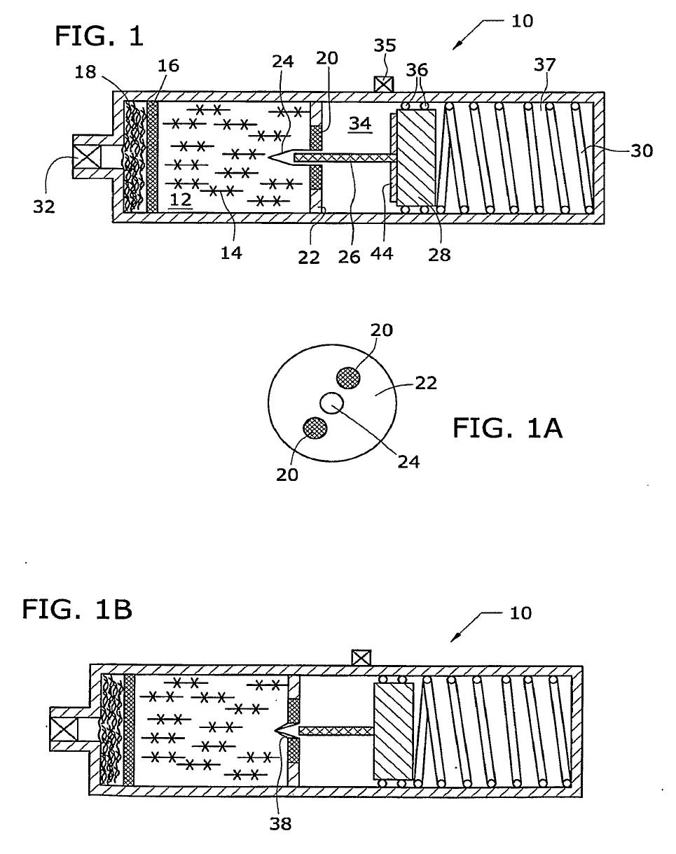

As shown in FIG. 1, gas generator 10 comprises gel chamber 12 containing the water-gel composition described above, designated by reference number 14 hereinafter. Gel 14 is enclosed on one side by screen 16 and optional filter 18, and on the other side by screen 20. Screen 20, which may be any type of screen, filter, or gas-permeable/liquid impermeable material known in the art, may by supported by wall 22, as shown in more detail in FIG. 1A. Wall 22 supports valve 24, which in this embodiment is preferably a duckbill valve. Duckbill 24 is sized and dimensioned to receive solid fuel 26, which as described above preferably comprises a metal hydride fuel, such as sodium borohydride, and a catalyst, such as ruthenium salt. Solid fuel 26 is attached to a movable sealing piston 28, which is biased by spring 30 toward gel fuel 14.

When solid fuel 26 is brought into contact with gel fuel 14, hydrogen gas is produced and percolates through screen 16 and optional filter 16 toward valve 32. When valve 32 is opened, the gas is transported outside of generator 10 to a fuel cell (not shown) for conversion into electricity. A portion of the produced gas also percolates through opposite screen(s) 20, so that the pressure created by the generated gas is communicated into chamber 34. Since piston 28 is sealed by sealing members 36, the pressure in chamber 34 is isolated form the pressure in chamber 37 located on the other side of piston 28, so that the pressure in chamber 34 acts on piston 28 and is opposed by the force from spring 30. Screen(s) 20 equalizes the pressure in gel chamber 12 to chamber 34. If the pressure inside gel chamber 12, where the reaction takes place, is higher than a predetermined threshold, then that pressure acts on piston 28 to push it against spring 30 to withdraw solid fuel 26 from gel reservoir 12. When the pressure inside gel chamber 12 drops below the threshold pressure, spring 30 overcomes the pressure in chamber 34 to insert or re-insert solid fuel 26 into gel reservoir 12. Due to the balancing between the pressure in chamber 34 and spring 30, solid fuel rod 26 may in fully inserted, partially inserted or fully withdrawn from gel reservoir 12. When valve 32 is closed, the pressure would exceed the threshold pressure and solid fuel 26 would be fully withdrawn. Hence, gas generator is self-regulating depending on the internal pressure of gas generator 10.

Duckbill 24, when assembled in the orientation shown in FIG. 1, may advantageously wipe some or most of the gel fuel from solid fuel 26, as it is withdrawn, to minimize residual reaction after the solid fuel is withdrawn. Alternatively, as shown in FIG. 1B, duckbill 24 may be replaced by wipers 38. Screen 20 may be replaced by vents or any other pressure communicating mechanism. While only two screens 20 are illustrated, any number of pressure communicating mechanisms can be used.

Before the first use by the users, chamber 34 may be pressurized by an inert gas to keep solid fuel 26 separated from gel fuel 14, or piston 28 may be held in a position that separates solid fuel 26 from gel fuel 14 until the users pull a tab or similar device to release piston 28. Valve 32 would then be opened to release the generated gas, and depending on the volume of gas used, gas generator 10 self-regulates its internal pressure, as described above, at a predetermined level. Gas generator 10 slows or stops the reaction when gas usage is low and internal pressure is high, or allows full production when gas usage is high and internal pressure is low. This predetermined pressure level can be selected by selecting the spring constant of spring 30. As will be recognized by those in the art, spring 30 is not limited to helical springs, but may include other mechanical springs, such as torsion springs, pressurized gas, and liquefied hydrocarbons such as butane or propane. Additionally, the restorative force provided by spring 30 may instead be provided by the in situ production of gas, as described in detail in U.S. Patent Pub. No. US 2005/0266281 A1, which is incorporated herein in its entirety by reference.

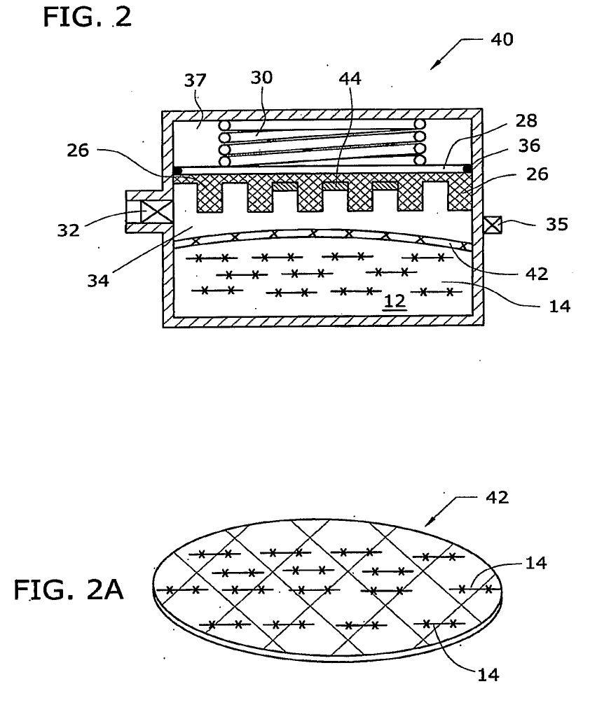

Another gas generator 40 suitable for use with the water-gel composition 14 of the present invention is shown in FIG. 2. One difference between gas generator 40 and gas generator 10 of FIGS. 1-1B, is that the generated gas is produced or transported to the fuel cell from pressure chamber 34, whose pressure also acts on solid fuel 26 to allow the solid fuel to come into contact with water-gel 14 or to withdraw the solid fuel from the water-gel fuel. Also, solid fuel 26 may have one or multiple protrusions that come into contact with water-gel 14. The solid fuel shown in FIGS. 1 and 1B may also have multiple points of contact with water-gel 14.

Similar to gas generator 10, solid fuel 26 is biased by spring 30 and pressure chamber 34 is sealed by piston 28 and sealing elements 36 from chamber 37 behind piston 28, so that the pressure of chamber 34 can be balanced by spring 30. When pressure in pressure chamber 34 exceeds a predetermined level, solid fuel 26 is pushed against spring 30 to withdraw the solid fuel from water-gel 14 to decrease or stop gas production to minimize or stop further pressure build-up in chamber 34. When valve 32 is opened, the produced gas is transported from chamber 34 to the fuel cell and the pressure of chamber 34 decreases, spring 30 then pushes solid fuel 26 into contact with water-gel 14 to produce more gas. As the demand for the produced gas varies, the pressure in chamber 34 also varies and the interaction between this pressure and the force from spring 30 controls the amount of contact between solid fuel 26 and water-gel fuel 14 to match the production of gas to the demand for gas. When valve 32 is closed, the pressure of chamber 34 increases to above the predetermined threshold amount and separates the solid fuel from the water-gel fuel.

In gas generator 40, water-gel fuel 14 is contained by screen 42, which is sized and dimensioned to allow the protrusions of solid fuel 26 to enter and exit therefrom. Since the gel is viscous or has high surface tension, screen 42 can contain water-gel 14 within gel chamber 12.

In an alternative embodiment, methanol gel can be used instead of water-gel 14. Methanol gel is well known and has been widely used in the food catering industry as a combustible fuel to warm foods.

Pressure chamber 34 may also be provided with relief valve 35 so that excess produced gas may be relieved from gas generator 10, 40. Alternatively, a hydrogen storage element 44 may be positioned in chamber 34 of generators 10, 40 and/or in other locations, e.g., within filter 18 or proximate to valve 32 of generator 10 to absorb excess hydrogen.

Hydrogen storage materials 44 include, but are not limited to, powder metal or powder metal alloys, known as hydrogen sorbent metals/alloys. These metals or metal alloys are capable of absorbing hydrogen at high pressure to form metal hydrides such as those disclosed in U.S. Pat. Nos. 4,600,525 and 4,036,944, which are incorporated herein by referenced in their entireties. Hydrogen sorbent metals 44 are different from solid metal hydride fuel 14 (e.g., sodium borohydride) in that is does not react with water or methanol to produce hydrogen.

Hydrogen-sorbent metals 44 absorb hydrogen to form metal hydrides in an exothermic reaction at high pressure and release the hydrogen in an endothermic reaction at lower pressure. Hence, the hydrogen-sorbent metal/alloy can undergo cycles of hydrogen absorptions, e.g., at a manufacturing or recharging facility, and hydrogen desorptions, e.g., to a fuel cell for conversion into electricity. Examples of hydrogen sorbent metals typically in powder form include lanthanum pentanickle (LaNi₅). Some suitable hydrogen-sorbent metals/alloys are available as Solid-H™ metal hydrides from Hydrogen Components, Inc. The Solid-H™ metal hydrides are available in several grades. All grades can absorb hydrogen at or near room temperature and at pressures of 1-10 atmospheres, 2-3 atmospheres and 8-12 atmospheres (1 atmosphere=14.7 psi). The alloy grade that can absorb hydrogen at 2-3 atmospheres or 30-45 psi is preferred, since this is the range of pressure in generators 10, 40 where absorption of hydrogen is preferred.

The absorbed hydrogen can remained absorbed, or may be released at lower pressure and with the addition of heat. For example, the heat may be supplied by the exothermic reaction of the sodium borohydride reaction with water.

Other hydrogen-sorbent materials include NaAlH₄ (sodium alanate), PdH_{0.6}, LaNi₅H₆, ZrV₂H_{5.5}, FeTiH₂, Mg₂NiH₄ and TiV₂H₄, or blends thereof. Other hydrogen-sorbent alloys can be found on a website, http://hydpark.ca.sandia.gov, maintained by the Sandia National Laboratories as a part of the International Energy Agency (IEA) Hydrogen Agreement Task 12, as discussed in Sandrock, G. & Thomas, G., The IEA/DOE/SNL On-line Hydride Databases, Appl. Phys. A72, 153-55 (2001). Hydrogen-sorbent alloys can also be blended with a polymeric binder.

While various embodiments of the present invention have been described above, it should be understood that they have been presented by way of illustration and example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entireties.

1. A fuel composition capable of producing hydrogen through a chemical reaction for use in a fuel cell wherein the fuel composition comprises a gel reactant, a chemical metal hydride reactant and a catalyst.

2. The fuel composition of claim 1, wherein the gel reactant comprises water and a water-insoluble, water-swellable polymer.

3. The fuel composition of claim 2, wherein the water molecules are bonded to the water-insoluble, water-swellable polymer by hydrogen bonds.

4. The fuel composition of claim 2, wherein the water-insoluble, water-swellable polymer comprises sodium polyacrylate.

5. The fuel composition of claim 2, wherein the water-insoluble, water-swellable polymer comprises polyacrylamide.

6. The fuel composition of claim 1, wherein the chemical metal hydride reactant comprises sodium borohydride.

7. The fuel composition of claim 1, wherein the catalyst comprises ruthenium salt.

8. The fuel composition of claim 1, wherein the catalyst is mixed or blended with the chemical metal hydride to form a solid reactant.

9. A gas generator adapted for use with the fuel composition of claim 8 comprising
a chamber containing the gel reactant and wherein the solid reactant is positioned on a biased platform and the solid reactant is movable relative to the gel reactant, wherein the gel reactant is spaced from the platform to form a pressure chamber and wherein the gas produced from a reaction between the gel reactant and the metal hydride reactant creates a pressure within the pressure chamber, and when said pressure is higher than a predetermined pressure the solid reactant is moved away from the gel reactant and when said pressure is lower than the predetermined pressure the solid reactant is moved toward the gel reactant.

10. The gas generator of claim 9, wherein the produced gas is transported from the pressure chamber to a fuel cell.

11. The gas generator of claim 9, wherein the produced gas is transported from the gas generator at a location away from the pressure chamber to a fuel cell.

12. The gas generator of claim 9 further comprising a hydrogen sorbent alloy/metal to absorb excess hydrogen.

13. A gas generator capable of producing hydrogen through an oxidation reaction and containing a liquid reactant and a chemical metal hydride, said gas generator comprises a hydrogen sorbent alloy/metal to absorb excess hydrogen.
